(19) United States
(12) Patent Application Publication
(10) Pub. No.: US 2024/0397975 A1
(43) Pub. Date: Dec. 5, 2024

(54) EMULSION AND USE OF A PHOSPHOLIPID COMPOSITION

(71) Applicant: Bunge Loders Croklaan B.V., Wormerveer (NL)

(72) Inventors: Bastiaan Jeroen Victor VERKUIJL, Wormerveer (NL); Alan Louis KELLY, Cork (IE); Patrycja Irena Zakrys-Waliwander, Cork (IE)

(21) Appl. No.: 18/699,184

(22) PCT Filed: Oct. 7, 2022
(86) PCT No.: PCT/EP2022/077895

§ 371 Date: Apr. 5, 2024

(30) Foreign Application Priority Data
Oct. 8, 2021 (EP) 21201666.1

(51) Int. Cl. A23J 7/00; A23L 29/10; A23L 33/00; A23L 33/12

(52) U.S. Cl. CPC A23J 7/00; A23L 29/10; A23L 33/12; A23L 33/40

(57) ABSTRACT

Disclosed herein is the use of a plant-based phospholipid composition as emulsifier in an emulsion containing OPO triglyceride. Also disclosed herein is an emulsion, as well as infant formula and toddler formula containing the stabilized emulsion.

This invention relates to the use of a plant-based phospholipid composition as emulsifier in an emulsion containing OPO triglyceride. The invention also relates to the emulsion, as well as infant formula and toddler formula containing the stabilized emulsion.

### BACKGROUND

Fats and oils are important ingredients of food products and used extensively in the food industry. Fat compositions containing similar amounts of the principal fatty acids found in human milk fat may be derived from oils and fats of vegetable origin. However, there remains a significant difference in composition between human milk fat and fat compositions derived from vegetable oils or fats.

Certain triglycerides are nutritionally important. For example, the triglyceride 1,3-dioleoyl-2-palmitoylglycerol (OPO) is known to be an important component of human milk fat. These triglycerides are believed to have important dietary consequences, in particular when these triglycerides are nutritionally balanced in the composition. In order to obtain these triglycerides which closely match the chemical and/or physical properties of those of human milk fat, it is necessary to control the distribution of the fatty acid residues on the glyceride positions (1,3- or 2-).

Infant formula is comprised of lipids, proteins, carbohydrates, water and additional minor ingredients. These ingredients have markedly different hydrophobicity or hydrophilicity. They range from strongly hydrophobic (lipids), amphiphilic (proteins) to hydrophilic (water, carbohydrates) and all of the above (minor ingredients). To avoid phase separation of these ingredients, the ingredients are usually emulsified with the use of a homogenizer which is a standard piece of equipment used in the dairy and infant formula industry.

A stable infant formula emulsion which closely resembles human breast milk is crucial to provide optimal bioavailability of nutrients which ultimately benefits the development of the infant.

CN112385845A discloses structured emulsions rich in OPO triglyceride for infant formula by using a combination of milk fat phospholipid and plant phospholipid.

CN112205475A similarly discloses structured emulsions of vegetable oil which does not contain OPO triglyceride for infant formula by using soybean lecithin and milk sphingomyelin.

However, there is no disclosure of using a simple plant-based phospholipid composition to improve the stability of an emulsion containing OPO triglyceride. There is also no disclosure of such a stabilized emulsion, or an infant formula and toddler formula containing the stabilized emulsion.

There remains a need for a suitable and simple phospholipid composition to improve the stability of the emulsion containing the triglycerides mimicking human milk fat, such as OPO triglyceride, so that the emulsion can more closely resemble human breast milk, thereby providing the optimal bioavailability of nutrients. There is also a need for an emulsion having desired stability during the whole production process.

### DESCRIPTION OF THE INVENTION

According to the present invention, there is provided the use of a plant-based phospholipid composition as emulsifier in an emulsion containing OPO triglyceride, wherein the phospholipid composition has a weight ratio of phosphatidylethanolamine (PE) to phosphatidylinositol (PI) of at most 0.70 based on the total amount of polar lipids in the composition.

There is also provided an emulsion comprising OPO triglyceride and a plant-based phospholipid composition, wherein the phospholipid composition has a weight ratio of phosphatidylethanolamine (PE) to phosphatidylinositol (PI) of at most 0.70 based on the total amount of polar lipids in the composition.

There is also provided a method of increasing the stability an emulsion containing OPO triglyceride, comprising the step of adding a plant-based phospholipid composition to the emulsion, wherein the phospholipid composition has a weight ratio of phosphatidylethanolamine (PE) to phosphatidylinositol (PI) of at most 0.70 based on the total amount of polar lipids in the composition.

It has been surprisingly found that by using a simple plant-based phospholipid composition with the required weight ratio of phosphatidylethanolamine (PE) to phosphatidylinositol (PI), the emulsion has an improved stability during and after the production process which is believed to result from a particularly desirable fat globule architecture. Such a stable emulsion is particularly suitable for infant formula or toddler formula. The emulsion according to the invention is particularly preferred to be used prior to spray drying during the production of infant formula or toddler formula.

The term “plant-based phospholipid composition” refers to a phospholipid composition originating from any plant source. Examples of a plant-based phospholipid composition include lecithin derived from sunflower, soybean or rapeseed. Typically, the plant-based phospholipid composition may contain at least 30% by weight of polar lipids, preferably at least 40% by weight of polar lipids and more preferably at least 50% by weight of polar lipids.

The term “emulsifier” refers to a component which improves the stability of an emulsion by decreasing the propensity of the emulsion to phase separate. Without wishing to be bound by theory, it is believed that the emulsifier used in the present invention acts as a functional composition to coat the droplet surface in order to provide an energy barrier reducing the chance of coalescence of colliding droplets in the emulsion. The addition of an emulsifier to an emulsion may lead to a decrease in the instability index.

The instability index is quantified by the clarification at a given separation time, divided by the maximum clarification. The clarification quantifies the increase in transmission (decrease of particle concentration) due to phase separation by sedimentation or creaming/flotation. The instability index is a dimensionless number between zero and 1. “Zero” means no changes of particle concentration (very stable) and “1” means that dispersion has completely phase separated (very unstable). More explanations regarding the instability index may be found in the literatures such as Detloff T, Sobisch T, Lerche D (2013) Instability index. Dispersion Letters Technical T4 1-4, ISBN: 978-3-944261-29-4.

The term “polar lipids” or “polar lipid components” in the plant-based phospholipid composition refers to the phospholipid components possessing a dipole moment, such as phosphatidylethanolamine (PE), phosphatidylinositol (PI), phosphatidylcholine (PC), phosphatidylserine (PS), phosphatidic acid (PA) and sphingomyelin (SM). These components may be measured by NMR spectroscopy as is known in the art.

The plant-based phospholipid composition according to the invention has a weight ratio of phosphatidylethanolamine (PE) to phosphatidylinositol (PI) of at most 0.70 based on the total amount of polar lipids in the composition, preferably at most 0.60, more preferably from 0.10 to 0.55 and even more preferably from 0.20 to 0.50.

The plant-based phospholipid composition according to the invention preferably has a phosphatidylcholine (PC) content of from 10% to 50% by weight based on the total amount of polar lipids in the composition, more preferably from 20% to 45% by weight and even more preferably from 25% to 40% by weight.

The plant-based phospholipid composition according to the invention preferably has a phosphatidylethanolamine (PE) content of at most 30% by weight based on the total amount of polar lipids in the composition, more preferably from 5% to 25% by weight and even more preferably from 10% to 18% by weight.

The plant-based phospholipid composition according to the invention preferably has a phosphatidylserine (PS) content of at most 10% by weight based on the total amount of polar lipids in the composition, more preferably at most 5% by weight and even more preferably at most 3% by weight.

The plant-based phospholipid composition according to the invention preferably has a phosphatidylinositol (PI) content of from 10% to 50% by weight based on the total amount of polar lipids in the composition, more preferably from 20% to 40% by weight and even more preferably from 26% to 35% by weight.

The plant-based phospholipid composition according to the invention preferably has a phosphatidic acid (PA) content of at most 15% by weight based on the total amount of polar lipids in the composition, more preferably at most 12% by weight and even more preferably from 8% to 11% by weight.

The plant-based phospholipid composition according to the invention preferably has a sphingomyelin (SM) content of at most 3% by weight based on the total amount of polar lipids in the composition, more preferably at most 2% by weight, even more preferably at most 1% by weight and most preferably from 0% to 0.5% by weight.

In a preferred embodiment, the plant-based phospholipid composition according to the invention has a weight ratio of phosphatidylethanolamine (PE) to phosphatidylinositol (PI) of at most 0.60; a phosphatidylcholine (PC) content of from 10% to 50% by weight; a phosphatidylethanolamine (PE) content of at most 30% by weight; a phosphatidylserine (PS) content of at most 10% by weight; a phosphatidylinositol (PI) content of from 10% to 50% by weight; a phosphatidic acid (PA) content of at most 15% by weight; and a sphingomyelin (SM) content of at most 3% by weight; based on the total amount of polar lipids in the composition.

In a more preferred embodiment, the plant-based phospholipid composition according to the invention has a weight ratio of phosphatidylethanolamine (PE) to phosphatidylinositol (PI) of from 0.10 to 0.55; a phosphatidylcholine (PC) content of from 20% to 45% by weight; a phosphatidylethanolamine (PE) content of from 5% to 25% by weight; a phosphatidylserine (PS) content of at most 5% by weight; a phosphatidylinositol (PI) content of from 20% to 40% by weight; a phosphatidic acid (PA) content of at most 12% by weight; and a sphingomyelin (SM) content of at most 2% by weight; based on the total amount of polar lipids in the composition.

In an even more preferred embodiment, the plant-based phospholipid composition according to the invention has a weight ratio of phosphatidylethanolamine (PE) to phosphatidylinositol (PI) of from 0.20 to 0.50; a phosphatidylcholine (PC) content of from 25% to 40% by weight; a phosphatidylethanolamine (PE) content of from 10% to 18% by weight; a phosphatidylserine (PS) content of at most 3% by weight; a phosphatidylinositol (PI) content of from 26% to 35% by weight; a phosphatidic acid (PA) content of from 8% to 11% by weight; and a sphingomyelin (SM) content of at most 1% by weight; based on the total amount of polar lipids in the composition.

The plant-based phospholipid composition according to the invention is preferably a lecithin and more preferably a lecithin derived from sunflower.

There is preferably provided the use of a plant-based lecithin as emulsifier in an emulsion containing OPO triglyceride, wherein the lecithin has a weight ratio of phosphatidylethanolamine (PE) to phosphatidylinositol (PI) at most 0.70 based on the total amount of polar lipids in the lecithin.

There is also preferably provided an emulsion comprising OPO triglyceride and a plant-based lecithin, wherein the lecithin has a weight ratio of phosphatidylethanolamine (PE) to phosphatidylinositol (PI) at most 0.70 based on the total amount of polar lipids in the lecithin.

There is also preferably provided a method of increasing the stability an emulsion containing OPO triglyceride, comprising the step of adding a plant-based lecithin to the emulsion, wherein the lecithin has a weight ratio of phosphatidylethanolamine (PE) to phosphatidylinositol (PI) of at most 0.70 based on the total amount of polar lipids in the lecithin.

In preferred emulsions, uses and methods, the lecithin has a weight ratio of phosphatidylethanolamine (PE) to phosphatidylinositol (PI) at most 0.60; a phosphatidylcholine (PC) content of from 10% to 50% by weight; a phosphatidylethanolamine (PE) content of at most 30% by weight; a phosphatidylserine (PS) content of at most 10% by weight; a phosphatidylinositol (PI) content of from 10% to 50% by weight; a phosphatidic acid (PA) content of at most 15% by weight; and a sphingomyelin (SM) content of at most 3% by weight; based on the total amount of polar lipids in the lecithin.

In more preferred emulsions, uses and methods, the lecithin has a weight ratio of phosphatidylethanolamine (PE) to phosphatidylinositol (PI) from 0.10 to 0.55; a phosphatidylcholine (PC) content of from 20% to 45% by weight; a phosphatidylethanolamine (PE) content of from 5% to 25% by weight; a phosphatidylserine (PS) content of at most 5% by weight; a phosphatidylinositol (PI) content of from 20% to 40% by weight; a phosphatidic acid (PA) content of at most 12% by weight; and a sphingomyelin (SM) content of at most 2% by weight; based on the total amount of polar lipids in the lecithin.

In even more preferred emulsions, uses and methods, the lecithin has a weight ratio of phosphatidylethanolamine (PE) to phosphatidylinositol (PI) from 0.20 to 0.50; a phosphatidylcholine (PC) content of from 25% to 40% by weight; a phosphatidylethanolamine (PE) content of from 10% to 18% by weight; a phosphatidylserine (PS) content of at most 3% by weight; a phosphatidylinositol (PI) content of from 26% to 35% by weight; a phosphatidic acid (PA) content of from 8% to 11% by weight; and a sphingomyelin (SM) content of at most 1% by weight; based on the total amount of polar lipids in the lecithin.

The emulsion according to the invention preferably comprises from 0.10% to 1.00% by weight of a plant-based phospholipid composition based on the total weight of the emulsion, more preferably from 0.15% to 0.80% by weight and even more preferably from 0.20% to 0.70% by weight.

The emulsion according to the invention preferably comprises at most 40% by weight of oil based on the total weight of the emulsion, more preferably from 1% to 25% by weight and even more preferably from 3% to 15% by weight.

The emulsion according to the invention preferably comprises from 30% to 95% by weight of water based on the total weight of the emulsion, more preferably from 40% to 90% by weight and even more preferably from 50% to 88% by weight.

In a preferred embodiment, there is provided the use of a plant-based composition or lecithin as emulsifier in an emulsion containing OPO triglyceride, wherein the composition or lecithin has a weight ratio of phosphatidylethanolamine (PE) to phosphatidylinositol (PI) at most 0.60; a phosphatidylcholine (PC) content of from 10% to 50% by weight; a phosphatidylethanolamine (PE) content of at most 30% by weight; a phosphatidylserine (PS) content of at most 10% by weight; a phosphatidylinositol (PI) content of from 10% to 50% by weight; a phosphatidic acid (PA) content of at most 15% by weight; and a sphingomyelin (SM) content of at most 3% by weight; based on the total amount of polar lipids in the composition or lecithin; and wherein the emulsion comprises from 0.10% to 1.00% by weight of a plant-based composition or lecithin; at most 40% by weight of oil; and from 30% to 95% by weight of water; based on the total weight of the emulsion.

In another preferred embodiment, there is provided an emulsion comprising OPO triglyceride and a plant-based composition or lecithin, wherein the composition or lecithin has a weight ratio of phosphatidylethanolamine (PE) to phosphatidylinositol (PI) at most 0.60; a phosphatidylcholine (PC) content of from 10% to 50% by weight; a phosphatidylethanolamine (PE) content of at most 30% by weight; a phosphatidylserine (PS) content of at most 10% by weight; a phosphatidylinositol (PI) content of from 10% to 50% by weight; a phosphatidic acid (PA) content of at most 15% by weight; and a sphingomyelin (SM) content of at most 3% by weight; based on the total amount of polar lipids in the composition or lecithin; and wherein the emulsion comprises from 0.10% to 1.00% by weight of a plant-based composition or lecithin; at most 40% by weight of oil; and from 30% to 95% by weight of water; based on the total weight of the emulsion.

In another preferred embodiment, there is provided a method of increasing the stability an emulsion containing OPO triglyceride, comprising the step of adding a plant-based phospholipid composition or lecithin to the emulsion, wherein the composition or lecithin has a weight ratio of phosphatidylethanolamine (PE) to phosphatidylinositol (PI) at most 0.60; a phosphatidylcholine (PC) content of from 10% to 50% by weight; a phosphatidylethanolamine (PE) content of at most 30% by weight; a phosphatidylserine (PS) content of at most 10% by weight; a phosphatidylinositol (PI) content of from 10% to 50% by weight; a phosphatidic acid (PA) content of at most 15% by weight; and a sphingomyelin (SM) content of at most 3% by weight; based on the total amount of polar lipids in the composition or lecithin; and wherein the emulsion comprises from 0.10% to 1.00% by weight of a plant-based composition or lecithin; at most 40% by weight of oil; and from 30% to 95% by weight of water; based on the total weight of the emulsion.

In a more preferred emulsion, use or method, the composition or lecithin has a weight ratio of phosphatidylethanolamine (PE) to phosphatidylinositol (PI) from 0.10 to 0.55; a phosphatidylcholine (PC) content of from 20% to 45% by weight; a phosphatidylethanolamine (PE) content of from 5% to 25% by weight; a phosphatidylserine (PS) content of at most 5% by weight; a phosphatidylinositol (PI) content of from 20% to 40% by weight; a phosphatidic acid (PA) content of at most 12% by weight; and a sphingomyelin (SM) content of at most 2% by weight; based on the total amount of polar lipids in the composition or lecithin; and wherein the emulsion comprises from 0.15% to 0.80% by weight of a plant-based composition or lecithin; from 1% to 25% by weight of oil; and from 40% to 90% by weight of water; based on the total weight of the emulsion.

In an even more preferred emulsion, use or method, the composition or lecithin has a weight ratio of phosphatidylethanolamine (PE) to phosphatidylinositol (PI) from 0.20 to 0.50; a phosphatidylcholine (PC) content of from 25% to 40% by weight; a phosphatidylethanolamine (PE) content of from 10% to 18% by weight; a phosphatidylserine (PS) content of at most 3% by weight; a phosphatidylinositol (PI) content of from 26% to 35% by weight; a phosphatidic acid (PA) content of from 8% to 11% by weight; and a sphingomyelin (SM) content of at most 1% by weight; based on the total amount of polar lipids in the composition or lecithin; and wherein the emulsion comprises from 0.20% to 0.70% by weight of a plant-based composition or lecithin; from 3% to 15% by weight of oil; and from 50% to 88% by weight of water; based on the total weight of the emulsion.

Preferably, the oil used in the emulsion according to the invention comprises from 10% to 70% by weight of triglycerides having a carbon number of 52 based on the total weight of triglycerides; from 5% to 50% by weight of palmitic acid acyl groups based on the total weight of fatty acids present as acyl groups; and wherein at least 40% by weight of the palmitic acid acyl groups are present at the Sn2 position of the triglyceride based on total weight of palmitic acid present as acyl groups in the triglycerides.

More preferably, the oil used in the emulsion according to the invention comprises from 15% to 65% by weight of triglycerides having a carbon number of 52 based on the total weight of triglycerides; from 10% to 42% by weight of palmitic acid acyl groups based on the total weight of fatty acids present as acyl groups; and wherein at least 42% by weight of the palmitic acid acyl groups are present at the Sn2 position of the triglyceride based on total weight of palmitic acid present as acyl groups in the triglycerides.

Even more preferably, the oil used in the emulsion according to the invention comprises from 18% to 50% by weight of triglycerides having a carbon number of 52 based on the total weight of triglycerides; from 15% to 40% by weight of palmitic acid acyl groups based on the total weight of fatty acids present as acyl groups; and wherein at least 45% by weight of the palmitic acid acyl groups are present at the Sn2 position of the triglyceride based on total weight of palmitic acid present as acyl groups in the triglycerides.

The term “oil” is used synonymously with “fat” which refers to glyceride fats and oils containing fatty acid acyl groups and does not imply any particular melting point.

The term “fatty acid” refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. The fatty acid profile may be determined by fatty acid methyl ester analysis (FAME) using gas chromatography according to ISO 12966-2 and ISO 12966-4. Thus, percentages of fatty acids in compositions (e.g. palmitic acid (C16:0), stearic acid (C18:0), oleic acid (C18:1) etc.) referred to herein include both acyl groups such as tri-, di- and mono-glycerides and free fatty acids and are based on the total weight of C8 to C24 fatty acid residues.

The term “triglyceride” refers to glycerides consisting of three fatty acid chains covalently bonded to a glycerol molecule. Compositions of the invention contain oils that predominantly comprise triglycerides, for example at least 85% by weight of the oil is triglycerides, preferably at least 90% by weight of the oil is triglycerides.

Carbon number is the number of carbon atoms in the triglyceride (excluding the carbon atoms from the glycerol, as is standard practice). Carbon number levels can be determined by GC with pretreatment to remove the diglycerides (AOCS Ce 5-86).

Sn2 C16 refers to the percentage of C16:0 present in the 2-position of the triglyceride. The distribution of fatty acids in triglyceride can be determined after chemical degradation with a Grignard reagent according to Becker, C. C. et al. (1993) Lipids, 28, 147-149. The percentage of C16:0 residues in the 2-position is determined by finding: (a) the total C16:0 content of the fat by GC-FAME (ISO 12966-2 and ISO 12966-4); and (b) the C16:0 content of the 2-position by GC-FAME (ISO 12966-2 and ISO 12966-4) in 2-monoglyceride after chemical degradation with a Grignard reagent. The Sn-2 of C16:0 is thus ((b)×100)/((a)×3);

The oil used in the emulsion according to the invention preferably comprises at least 5% by weight of OPO triglycerides based on the total weight of triglycerides and more preferably at least 7% by weight.

The oil used in the emulsion according to the invention is preferably plant-based and preferably does not contain any oil or fat from animal origin.

The emulsion according to the invention preferably further comprises one or more ingredient selected from protein, carbohydrate, milk powder, minerals and vitamins.

The source of the protein is preferably selected from cows' milk proteins such as whey, casein and mixtures thereof, soy protein, potato protein, pea protein or sunflower protein. In case whey proteins are used, the protein source is preferably based on acid whey or sweet whey, whey protein isolate or mixtures thereof. Whey protein isolate is more preferred to be used.

In a preferred emulsion, use or method, the emulsion has a weight ratio of protein to plant-based phospholipid composition from 2:1 to 7:1, preferably from 3:1 to 6.5:1 and more preferably from 3.5:1 to 6:1. The preferred weight ratio of protein to plant-based phospholipid composition is particularly desired to render the emulsion even more stable.

The source of the carbohydrate is preferably a digestible carbohydrate and more preferably selected from lactose, glucose, sucrose, fructose, galactose, maltose, starch and maltodextrin. Lactose is more preferably to be used since lactose advantageously has a low glycaemic index.

Preferably the emulsion according to the invention further comprises fructo-oligosaccharides, galacto-oligosaccharides and/or galacturonic acid oligosaccharides, more preferably fructo-oligosaccharides and/or galacto-oligosaccharides, even more preferably galacto-oligosaccharides, most preferably transgalacto-oligosaccharides. In a preferred embodiment the emulsion according to the invention comprises a mixture of galacto-oligosaccharides and fructo-oligosaccharides, more preferably transgalacto-oligosaccharides and fructo-oligosaccharides.

In a preferred embodiment, there is provided the use according to the invention in infant formula or toddler formula. There is also provided infant formula or toddler formula comprising the emulsion of the invention. The term “infant formula” or “toddler formula” refers to a food for dietary use to feed babies and/or infants. Toddler formula, also understood as follow-on formula or transition formula, may specifically be preferred for babies of ages 6 months to 3 years.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

The following non-limiting examples illustrate the invention and do not limit its scope in any way. In the examples and throughout this specification, all percentages, parts and ratios are by weight unless indicated otherwise.

### Numbered Embodiments of the Invention

1. A method of increasing the stability an emulsion containing OPO triglyceride, comprising the step of adding a plant-based phospholipid composition to the emulsion, wherein the phospholipid composition has a weight ratio of phosphatidylethanolamine (PE) to phosphatidylinositol (PI) of at most 0.70 based on the total amount of polar lipids in the composition.
2. The method according to numbered embodiment 1, wherein the plant-based phospholipid composition has a weight ratio of phosphatidylethanolamine (PE) to phosphatidylinositol (PI) of at most 0.60 based on the total amount of polar lipids in the composition, preferably from 0.10 to 0.55 and more preferably from 0.20 to 0.50.
3. The method according to numbered embodiment 1 or 2, wherein the plant-based phospholipid composition has a phosphatidylcholine (PC) content of from 10% to 50% by weight based on the total amount of polar lipids in the composition, preferably from 20% to 45% by weight and more preferably from 25% to 40% by weight.
4. The method according to any one of the preceding numbered embodiments, wherein the plant-based composition a phospholipid has phosphatidylethanolamine (PE) content of at most 30% by weight based on the total amount of polar lipids in the composition, preferably from 5% to 25% by weight and more preferably from 10% to 18% by weight.
5. The method to any one of the preceding numbered embodiments, wherein the plant-based phospholipid composition has a phosphatidylserine (PS) content of at most 10% by weight based on the total amount of polar lipids in the composition, preferably at most 5% by weight and more preferably at most 3% by weight.
6. The method according to any one of the preceding numbered embodiments, wherein the plant-based phospholipid composition has a phosphatidylinositol (PI) content of from 10% to 50% by weight based on the total amount of polar lipids in the composition, preferably from 20% to 40% by weight and more preferably from 26% to 35% by weight.
7. The method according to any one of the preceding numbered embodiments, wherein the plant-based phospholipid composition has a phosphatidic acid (PA) content of at most 15% by weight based on the total amount of polar lipids in the composition, preferably at most 12% by weight and more preferably from 8% to 11% by weight.
8. The method according to any one of the preceding numbered embodiments, wherein the plant-based phospholipid composition has a sphingomyelin (SM) content of at most 3% by weight based on the total amount of polar lipids in the composition, preferably at most 2% by weight and more preferably at most 1% by weight.
9. The method according to any one of the preceding numbered embodiments, wherein the plant-based phospholipid composition is a lecithin derived from sunflower.
10. The method according to any one of the preceding numbered embodiments, wherein the emulsion comprises from 0.10% to 1.00% by weight of a plant-based phospholipid composition based on the total weight of the emulsion, preferably from 0.15% to 0.80% by weight and more preferably from 0.20% to 0.70% by weight.
11. The method according to any one of the preceding numbered embodiments, wherein the emulsion comprises at most 40% by weight of oil based on the total weight of the emulsion, preferably from 1% to 25% by weight and more preferably from 3% to 15% by weight.
12. The method according to any one of the preceding numbered embodiments, wherein the emulsion comprises from 30% to 90% by weight of water based on the total weight of the emulsion, preferably from 40% to 80% by weight and more preferably from 50% to 75% by weight.
13. The method according to any one of the preceding numbered embodiments, wherein the oil used in the emulsion comprises:
   from 10% to 70% by weight of triglycerides having a carbon number of 52 based on the total weight of triglycerides, preferably from 15% to 65% by weight and more preferably from 18% to 50% by weight;
   from 5% to 50% by weight of palmitic acid acyl groups based on the total weight of fatty acids present as acyl groups, preferably from 10% to 42% by weight and more preferably from 15% to 40% by weight; and
   wherein at least 40% by weight of the palmitic acid acyl groups are present at the Sn2 position of the triglyceride based on total weight of palmitic acid present as acyl groups in the triglycerides, preferably at least 42% and more preferably at least 45%.
14. The method according to any one of the preceding numbered embodiments, wherein the emulsion further contains one or more ingredients selected from protein such as whey protein isolate, carbohydrate such as lactose, milk powder, minerals and vitamins.
15. The method according to any one of the preceding numbered embodiments, wherein the emulsion has a weight ratio of protein to plant-based phospholipid composition from 2:1 to 7:1, preferably from 3:1 to 6.5:1 and more preferably from 3.5:1 to 6:1.
16. The method according to any one of the preceding numbered embodiments, wherein the emulsion is for use in infant formula or toddler formula.

### EXAMPLES

### Example 1—Composition of Betapol® 45

Betapol® 45 obtained from Bunge Loders Croklaan B.V. was used as OPO fat composition in the emulsions to be tested. Betapol® 45 contains at least 7% by weight of OPO triglycerides based on the total weight of triglycerides. The analytical results are shown in Table 1.

TABLE 1
Analytical results of Betapol ® 45

| | Betapol ® 45 |
|---|---|
| C8:0 | 1.1 |
| C10:0 | 0.9 |
| C12:0 | 12.0 |
| C14:0 | 4.4 |
| C15:0 | 0.0 |
| C16:0 | 22.9 |
| C16:1T | 0.0 |
| C16:1C | 0.1 |
| C17:0 | 0.1 |
| C18:0 | 2.9 |
| C18:1 | 39.3 |
| C18:1T | 0.2 |
| C18:1C | 39.1 |
| C18:2 | 13.9 |
| C18:2T | 0.2 |
| C18:2C | 13.7 |
| C18:3 | 1.5 |
| C18:3T | 0.1 |
| C18:3C | 1.3 |
| C20:0 | 0.3 |
| C20:1C | 0.3 |
| C20:2C | 0.0 |
| C22:0 | 0.2 |
| C22:1 | 0.1 |
| C22:1T | 0.0 |
| C22:1C | 0.1 |
| C24:0 | 0.1 |
| C24:1C | 0.0 |
| SAFA | 44.8 |
| MUFA | 39.7 |
| PUFA | 15.3 |
| Trans | 0.5 |
| Iodine value (IVFAME) | 62.0 |
| C26 | 0.0 |
| C28 | 0.1 |
| C30 | 0.5 |
| C32 | 1.5 |
| C34 | 2.5 |
| C36 | 5.6 |
| C38 | 4.6 |
| C40 | 2.6 |
| C42 | 2.4 |
| C44 | 1.8 |
| C46 | 1.6 |
| C48 | 4.8 |
| C50 | 16.6 |
| C52 | 25.8 |
| C54 | 27.9 |
| C56 | 1.0 |
| C58 | 0.3 |
| SN-2 C16 | 47.6 |

Cx:y refers to a fatty acid having x carbon atoms and y double bonds; levels determined by GC-FAME (ISO 12966-2 and ISO 12966-4); T denotes trans fatty acids and C denotes cis fatty acids;
Trans refers to trans fatty acids;
Cxx refers to a triglyceride having xx carbon atoms (excluding the carbon atoms from the glycerol, as is standard practice), with levels determined by GC with pretreatment to remove the diglycerides eventually (AOCS Ce 5-86); (values given for Betapol 45 are typical values);
SAFA, MUFA and PUFA refer to saturated, monounsaturated and polyunsaturated fatty acids, respectively;
Sn2 C16 refers to the percentage C16:0 present in the 2-monoglyceride in comparison of the percentage C16:0 in the test sample. The distribution of fatty acids in triglyceride was determined after chemical degradation with a Grignard reagent according to Becker, C. C. et al. (1993) Lipids, 28, 147-149. The percentage of C16:0 residues in the 2-position was determined by finding: (a) the total C16:0 content of the fat by GC-FAME (ISO 12966-2 and ISO 12966-4); and (b) the C16:0 content of the 2-position by GC-FAME (ISO 12966-2 and ISO 12966-4) in 2-monoglyceride after chemical degradation with a Grignard reagent. The Sn-2 of C16:0 was thus ((b)×100)/((a)×3); and
Iodine value (IVFAME) was calculated according to AOCS Cd 1c-85.

### Example 2—Composition of Lecithin Samples

Two types of commercially available lecithin were obtained from Bunge Limited and used for the preparation of the emulsions. One lecithin was derived from sunflower and another lecithin was derived from soybean. The composition of polar lipids in these two lecithin samples is shown in Table 2 and the percentages are based on the total amount of polar lipids in the lecithin.

TABLE 2
Polar lipid composition of two types of lecithin

| | Percentage by weight | |
|---|---|---|
| | Lecithin derived | Lecithin derived |
| | from sunflower | from soybean |
| Phosphatidylcholine (PC) | 35.4% | 36.3% |
| Phosphatidylethanolamine (PE) | 14.1% | 20.7% |
| Phosphatidylserine (PS) | 1.2% | 1.0% |
| Phosphatidylinositol (PI) | 30.1% | 24.1% |
| Phosphatidic acid (PA) | 9.6% | 6.7% |
| Sphingomyelin (SM) | 0% | 0% |
| Other polar lipids | 9.6% | 11.2% |
| Weight ratio of PE to PI (PE/PI) | 0.47 | 0.86 |

### Example 3—Preparation of the Emulsions

The emulsions were prepared according the following procedures:
1. Pre-heating distilled water to 50° C.
2. Mixing skim milk powder and whey protein isolate with water by using Silverson mixer at 4000 rpm for 5 minutes and then adding lactose to mix for another 5 minutes to obtain the water phase.
3. Incubating solutions at 55° C. for 10 minutes until all the powders are dissolved.
4. Heat the oil (Betapol® 45) to 55° C. until melted.
5. Dissolving lecithin in the oil to obtain the oil phase.
6. Emulsifying by mixing the water phase with the oil phase using Silverson mixer at 6000 rpm for up to 1 minute where the obtained globule size is 6-10 μm.
7. Adjusting the pH to 6.8 by using 2M NaOH solution.
8. Applying heat treatment simulating UHT by holding the emulsions at 80° C. for 10 minutes.
9. Homogenizing by using two-stage homogenization at 50 bar and 10 bar respectively.
10. Cooling the emulsions to 4° C. in the ice bath.

Three emulsions were prepared according to the procedure, one with the lecithin derived from sunflower oil, one with the lecithin derived from soybean as comparative example and one without lecithin as reference example. The preparation of these emulsions was according to the formulations as illustrated in Table 3.

TABLE 3
Formulation of the emulsions

| | | Emulsion B (using | | | |
|---|---|---|---|---|---|
| Emulsion A (using | | lecithin derived from | | Emulsion C (no use of | |
| lecithin derived | | soybean) - comparative | | lecithin) - reference | |
| from sunflower) | | example | | example | |
| Ingredient | Amount (g) | Ingredient | Amount (g) | Ingredient | Amount (g) |
| Skim milk | 6.6 | Skim milk | 6.6 | Skim milk | 6.6 |
| powder | | powder | | powder | |
| Whey protein | 7.4 | Whey protein | 7.4 | Whey protein | 7.4 |
| isolate | | isolate | | isolate | |
| Lactose | 61.3 | Lactose | 61.3 | Lactose | 63.0 |
| Oil | 28.1 | Oil | 28.1 | Oil | 28.1 |
| (Betapol ® 45) | | (Betapol ® 45) | | (Betapol ® 45) | |
| Lecithin | 1.7 | Lecithin | 1.7 | * | * |
| derived from | | derived from | | | |
| sunflower | | soybean | | | |
| Water | 195.0 | Water | 195.0 | Water | 195.0 |
| Total | 300.0 | Total | 300.0 | Total | 300.0 |

### Example 4—Particle Size Distribution Analysis of the Emulsions

Particle size analysis was performed using a laser diffractometer (Mastersizer 3000, Malvern Instruments). Particle size measurements were reported using D10, D50, D90 indicating the size below which 10%, 50% and 90% of all particles are found and volume moment mean (De Brouckere Mean Diameter) D[4, 3] reflecting the size of those particles which constitute the bulk of the sample volume. The results are shown in Table 4.

TABLE 4
Analysis of particle size distribution

| | Emulsion A | Emulsion B | Emulsion C |
|---|---|---|---|
| D10 | 0.28 | 0.266 | 0.276 |
| D50 | 1.31 | 1.14 | 1.46 |
| D90 | 3.75 | 4.3 | 6.21 |
| D[4,3] | 1.71 | 1.79 | 2.44 |

It can be seen that 90% of all particles found in Emulsion A is smaller than 3.75 μm and Emulsion A has also the smallest volume moment mean D[4,3]. It is believed that Emulsion A has an improved emulsion stability in view of the particle size distribution results compared to Emulsion B and Emulsion C.

### Example 5—Analysis of Instability Index

In order to further evaluate the emulsion stability, instability index was measured in these three emulsions. This stability test was conducted by LUMiFuge® and instability index was calculated using the SEPView® software.

The instability index is quantified by the clarification at a given separation time, divided by the maximum clarification. The clarification quantifies the increase in transmission (decrease of particle concentration) due to phase separation by sedimentation or creaming/flotation. The instability index is a dimensionless number between zero and 1. “Zero” means no changes of particle concentration (very stable) and “1” means that dispersion has completely phase separated (very unstable). More explanations regarding instability index may be found in the literatures such as Detloff T, Sobisch T, Lerche D (2013) Instability index. Dispersion Letters Technical T4 1-4, ISBN: 978-3-944261-29-4.

For each emulsion, three samples were taken for measuring instability index, before heat treatment simulating UHT (thus before step 8 in Example 3), after heat treatment simulating UHT (thus after step 8 in Example 3) and after the completion of the process (thus after step 10 in Example 3). The results of instability index are shown in Table 5.

TABLE 5
Instability index analysis

| Sample | Emulsion A | Emulsion B | Emulsion C |
|---|---|---|---|
| Before heat | 0.014 | 0.073 | 0.039 |
| treatment | | | |
| simulating UHT | | | |
| After heat | 0.030 | 0.091 | 0.145 |
| treatment | | | |
| simulating UHT | | | |
| After the | 0.001 | 0.004 | 0.001 |
| completion of | | | |
| the process | | | |

It could be observed that Emulsion A has the lowest instability index throughout the whole emulsifying process which indicates the improved stability not only in the final emulsion product but also during the processing compared to Emulsion B and Emulsion C. Such emulsion is suitable to be used in infant formula or toddler formula.

1. A method of using a plant-based phospholipid composition, the method comprising using the plant-based phospholipid composition as an emulsifier in an emulsion containing OPO triglyceride, wherein the phospholipid composition has a weight ratio of phosphatidylethanolamine (PE) to phosphatidylinositol (PI) of at most 0.70 based on the total amount of polar lipids in the composition.

2. An emulsion comprising OPO triglyceride and a plant-based phospholipid composition, wherein the phospholipid composition has a weight ratio of phosphatidylethanolamine (PE) to phosphatidylinositol (PI) of at most 0.70 based on the total amount of polar lipids in the composition.

3. The emulsion according to claim 2, wherein the plant-based phospholipid composition has a weight ratio of phosphatidylethanolamine (PE) to phosphatidylinositol (PI) of at most 0.60 based on the total amount of polar lipids in the composition.

4. The emulsion according to claim 2, wherein the plant-based phospholipid composition has a phosphatidylcholine (PC) content of from 10% to 50% by weight based on the total amount of polar lipids in the composition.

5. The emulsion according to claim 2, wherein the plant-based phospholipid composition has a phosphatidylethanolamine (PE) content of at most 30% by weight based on the total amount of polar lipids in the composition.

6. The emulsion according to claim 2, wherein the plant-based phospholipid composition has a phosphatidylserine (PS) content of at most 10% by weight based on the total amount of polar lipids in the composition.

7. The emulsion according to claim 2, wherein the plant-based phospholipid composition has a phosphatidylinositol (PI) content of from 10% to 50% by weight based on the total amount of polar lipids in the composition.

8. The emulsion according to claim 2, wherein the plant-based phospholipid composition has a phosphatidic acid (PA) content of at most 15% by weight based on the total amount of polar lipids in the composition.

9. The emulsion according to claim 2, wherein the plant-based phospholipid composition has a sphingomyelin (SM) content of at most 3% by weight based on the total amount of polar lipids in the composition.

10. The emulsion according to claim 2, wherein the plant-based phospholipid composition is a lecithin derived from sunflower.

11. The emulsion according to claim 2, wherein the emulsion comprises from 0.10% to 1.00% by weight of the plant-based phospholipid composition based on the total weight of the emulsion.

12. The emulsion according to claim 2, wherein the emulsion comprises at most 40% by weight of oil based on the total weight of the emulsion.

13. The emulsion according to claim 2, wherein the emulsion comprises from 30% to 95% by weight of water based on the total weight of the emulsion.

14. The emulsion according to claim 2, wherein the oil used in the emulsion comprises:
from 10% to 70% by weight of triglycerides having a carbon number of 52 based on the total weight of triglycerides;
from 5% to 50% by weight of palmitic acid acyl groups based on the total weight of fatty acids present as acyl groups; and
wherein at least 40% by weight of the palmitic acid acyl groups are present at the Sn2 position of the triglyceride based on total weight of palmitic acid present as acyl groups in the triglycerides.

15. The emulsion according to claim 2, wherein the emulsion has a weight ratio of protein to plant-based phospholipid composition from 2:1 to 7:1.

16. An infant formula or toddler formula comprising the emulsion according to claim 2.
